(19) United States
(12) Patent Application Publication
(10) Pub. No.: US 2011/0093328 A1
(43) Pub. Date: Apr. 21, 2011

(54) ITEM INFORMATION SYSTEM

(75) Inventor: Kenneth J. Woolcott, Seattle, WA (US)

(73) Assignee: SIX DEGREES CAPITAL CORPORATION, Seattle, WA (US)

(21) Appl. No.: 12/988,787

(22) PCT Filed: May 21, 2009
(86) PCT No.: PCT/US09/44811

§ 371 Date: Oct. 20, 2010

Related U.S. Application Data
(60) Provisional application No. 61/055,397, filed on May 22, 2008.
(60) Provisional application No. 61/117,518, filed on Nov. 24, 2008.

(51) Int. Cl. G06Q 30/00

(52) U.S. Cl. 705/14.41; 705/14.4; 705/14.73

(57) ABSTRACT

An item information system for providing item-related information includes an item mapping of item codes to item information related to the items and a user mapping of user identifiers to user information. Item codes are received via a communication link along with user identifiers of the users who submitted the item codes. The item codes are provided to the users via advertisements for the items. For each received item code, the corresponding item information is retrieved from the item mapping. An item message is sent from the item information system that includes a link to item information as indicated by the item mapping. The item information system enables a user to obtain an item code from an advertisement, submit the item code to the item information system, and receive the item information related to the item of the advertisement.

### CROSS REFERENCE TO RELATED APPLICATIONS

This application claims the benefit of U.S. Provisional Application Nos. 61/055,397 filed on May 22, 2008 and 61/117,518 filed on Nov. 24, 2008, the contents of which are both incorporated herein by reference.

### TECHNICAL FIELD

This disclosure relates generally to an item information system for advertising, informing about, reminding about, and/or selling products, services, or events.

### BACKGROUND INFORMATION

Advertising is a form of commercial communication that attempts to persuade potential customers to purchase a particular product or service, or inform these potential customers about a company and the products or services it has to offer. Non-commercial communication may also take the form of advertising or promotion in an attempt to persuade or inform the public about events, alerts, political matters, community decisions etc. In either case, traditional advertising has used media outlets including print media (e.g., magazines, newspapers, billboards, posters) and broadcast media (e.g., radio, television). While traditional advertising media has the ability to reach large numbers of potential customers for a reasonable price, it has not been particularly actionable, memorable, or measurable. From the potential customer's perspective, traditional advertising is not always actionable at the initial point of interest or at the initial time of interest. When presented with a traditional advertisement, such as, a magazine ad, a billboard, a radio ad, or television ad, the potential customer is not able to act on their curiosity to obtain more information or even purchase the advertised item. Similarly, unless the advertisement is particularly creative, these traditional advertisements do little to remind the potential customer to follow up on their initial interest in the item. The point of interest is often lost and does not directly translate to the point of sale. There are many barriers to the effectiveness of traditional advertising, including, the inability to effectively time-shift decision making about an initial interest and the inability to easily shift the evaluation of that initial interest in the often fleeting or one dimensional advertisement exposure to a more multi-dimensional environment such as the rich information gathering and networking possible on the Internet. For example, a customer interested in a product at the point of reading an advertisement may either forget an associated 800 number and/or the URL, fail to copy them down, not have immediate access to a computer, or simply not be inclined to access a URL or dial a toll free number at that particular time.

From the advertiser's perspective, traditional advertisements are relatively un-measurable to determine whether the advertisement dollars were well spent. Metrics on advertising effectiveness are highly desirable, but often challenging and expensive to obtain, if at all achievable. As such, traditional advertisement media cannot easily or efficiently inform the advertiser whether or not a particular advertisement strategy, placement, or campaign should be continued, repeated, or dropped.

Consequently, nontraditional advertising using the Internet has been gaining market share, since the arrival of companies like Google™ and Yahoo!™. An Internet based advertisement is able to provide immediate and actionable follow up information at the initial point of interest by virtue of the potential customer's simple click of a mouse. Click-through advertisements are easily measured to provide feedback to the advertiser to determine whether their ad dollars are well spent.

Despite the drawbacks of traditional advertising media, it remains a powerful, pervasive, and effective tool. A system capable of seamlessly and effortlessly translating the initial point of interest in an advertisement to a point of sale all while measuring the results of the traditional advertisement would solve a long felt need to make traditional media advertisements more actionable, memorable, and measurable. Such a system that captures more sales and provides valuable metrics for return on investment (ROI) analysis is the holy grail of the traditional advertising industry.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1 is a diagram illustrating a dataflow environment for operation of an item information system, in accordance with an embodiment of the invention.

FIG. 2 is a functional block diagram illustrating components associated with an item information system, in accordance with an embodiment of the invention.

FIG. 3A illustrates information stored in a user table and an item table, in accordance with an embodiment of the invention.

FIG. 3B illustrates information stored in an advertiser table and a transaction log, in accordance with an embodiment of the invention.

FIG. 4 is a flow chart illustrating a process for operation of a register items component of the item information system, in accordance with an embodiment of the invention

FIG. 5 is a flow chart illustrating a process for operation of a schedule items component of the item information system, in accordance with an embodiment of the invention.

FIG. 6 is a flow chart illustrating a process for operation of a calendar system component of the item information system, in accordance with an embodiment of the invention.

FIG. 7 is a flow diagram illustrating a process for operation of a perform accounting component of the item information system that performs accounting services for each advertiser, in accordance with an embodiment of the invention.

FIG. 8 illustrates an advertiser display page containing item information and links to related items, in accordance with an embodiment of the invention.

FIG. 9 is a block diagram illustrating a user display page that functions as a sort of consumer queue or user homepage, in accordance with an embodiment of the invention.

FIG. 10 illustrates tables containing item-related information for rendering service links within display pages, in accordance with an embodiment of the invention.

FIG. 11 is a flow chart illustrating a process for operation of a prepare display page component of the item information system, in accordance with an embodiment of the invention.

FIG. 12 is a flow chart illustrating a process for operation of an identify item services component of the item information system, in accordance with an embodiment of the invention.

### DETAILED DESCRIPTION

Embodiments of a method and system for providing information about items, such as products, services, and events, using item codes that are distributed via traditional advertisements are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

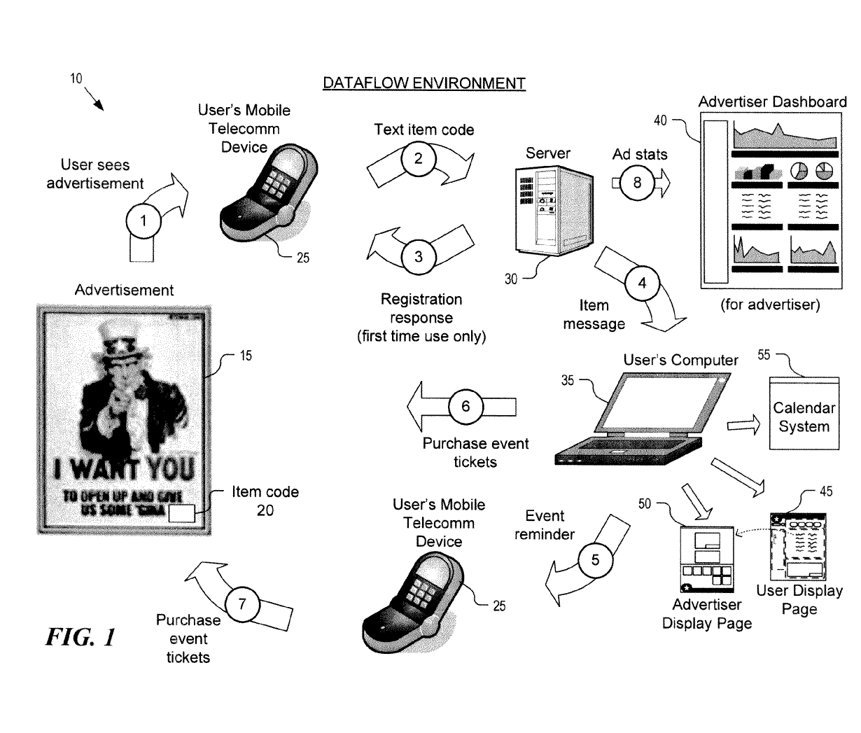

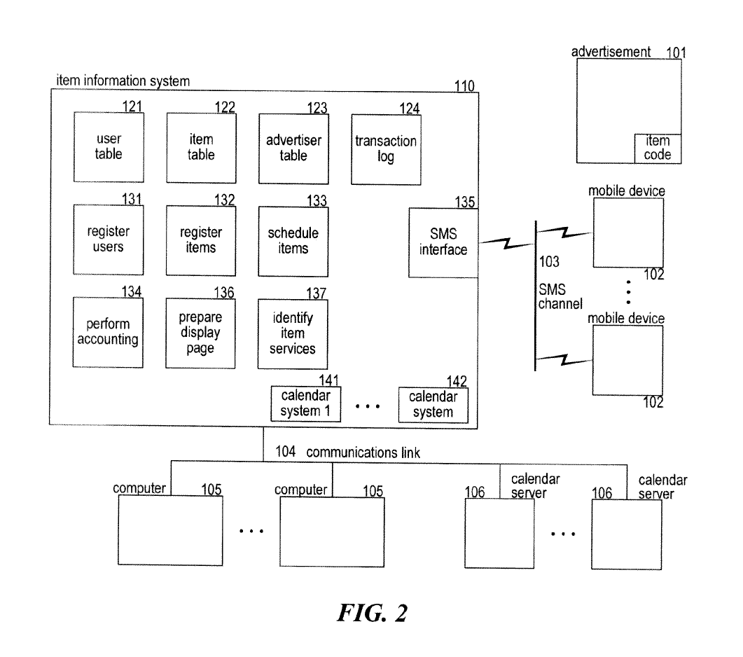

FIG. 1 is a diagram illustrating a dataflow environment 10 for operation of an item information system, in accordance with an embodiment of the invention. The illustrated embodiment of environment 10 includes a traditional advertisement 15 brandishing an item code 20, a mobile telecommunication device 25, a server 30, a user web browser enabled device 35, an advertiser dashboard 40, a user display page 45, a advertiser display page 50, and a calendar system 55. The item information system (e.g., item information system 110 illustrated in FIG. 2) is installed on server 30 to facilitate actionable, memorable, and measurable traditional advertising.

At arrow 1, a user, or potential customer, sees a traditional advertisement 15 for an item. The item may include any of an event (e.g., promotional sale, tickets to a play, a convention, etc.), a product, or a service (dry cleaning service, professional services, etc.), while advertisement 15 may be conveyed using any number of traditional advertising mediums, such as, a magazine, a newspaper, a billboard, a poster, the radio, the television, or otherwise. Advertisement 15 is coded, marked, or otherwise brandishes item code 20. Item codes my also be referred to as Ad Codes, as it is possible that the same item for sale may be given different codes based on segments of media or placement. In the case of a radio or television ad, advertisement 15 may be audibly marked with item code 20. If advertisement 15 is related to a promotional event, then item code 20 may be referred to as an event code, if related to a product, then item code 20 may be referred to as a product code, and similarly if related to a service, then item code may be referred to as a service code.

Upon seeing advertisement 15, the user can input item code 20 into their mobile telecommunication device 25 (e.g., cellular phone, smart phone with web browser functionality, etc.) if the user desires additional information or desires to shift further evaluation of the item to a later time. Item code 20 may take various forms and formats as discussed below; however, in one embodiment, item code 20 is a short and memorable alphanumeric code which the user texts (arrow 2) to a system number associated with the item information system operating on server 30. In one embodiment, the system number is also included on advertisement 15 adjacent to item code 20. In some embodiments, the item codes may additionally be delivered to server 30 via the user directly inputting the item code into a webpage hosted by server 30 or via a link related to an online advertisement.

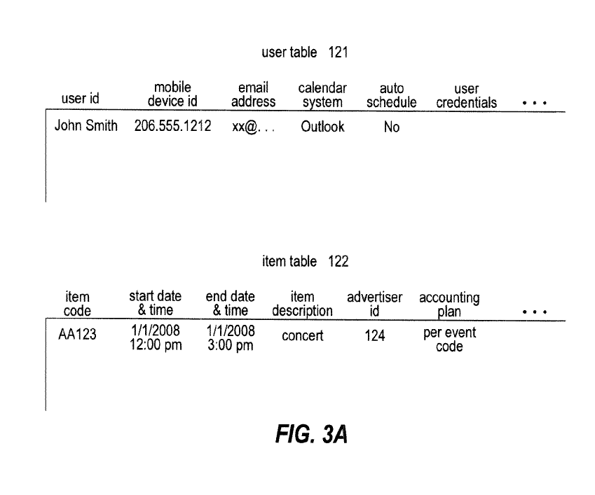

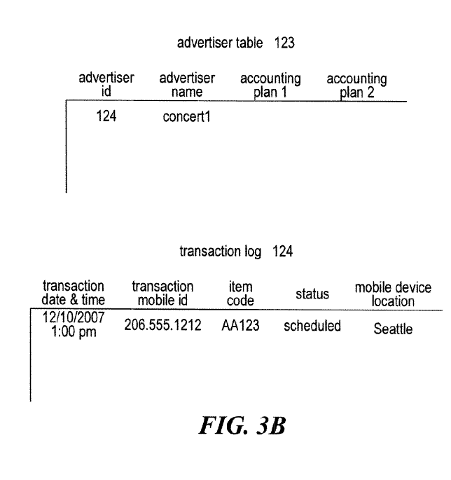

In one embodiment, if the text message is the first time the user has interacted with the item information system, then a registration response message (arrow 3) is sent back to the user's mobile telecommunication device 25 soliciting user information, such as that described in user table 121 of FIG. 3A. Alternatively, the registration response may include instructions or a hyperlink for logging into a webpage to setup the user account. For subsequent text messages after the user has been enrolled, the user information is recalled from memory on the server using a user identifier embedded in the text message (e.g., user's phone number).

After the user is registered and an item code received (arrow 2), the item information system may send an item message (arrow 4) to the user's web browser enabled device 35 (e.g., laptop computer, desktop computer, workstation computer, smart phone with web browser functionality, etc.). In one embodiment, this item message may be posted to a user display page 45 associated with the registered user's personal account. The registered user may select as a preference to also be notified by return text message or by email. In one embodiment, the item message includes a calendar request for scheduling a calendar event with calendar system 55 installed on the user's web browser enabled device 35. For example, if the item happens to be a promotional department store sale occurring during the Memorial Day Long weekend, the item message may include an event message for adding the long weekend sale to calendar system 55. The event message may also include information necessary to configuring calendar system 55 to reminder the user at a future date (arrow 5). In one embodiment, the event message may include a hyperlink to advertiser display page 50 including a representation of advertisement 15 and related information or a hyperlink to user display page 45 including a queue of item entries corresponding to recently submitted item codes. In one embodiment, the event message may further include direct hyperlinks to a website of the department store hosting the promotional event where electronic coupons or other related promotional offers may be provided. These links may also be embedded in advertiser display page 50. In an example where the event is a theatrical play, the event message may add the event to the user's calendar system and include hyperlinks to a website for conveniently purchasing tickets to the theatrical play and/or other related offerings.

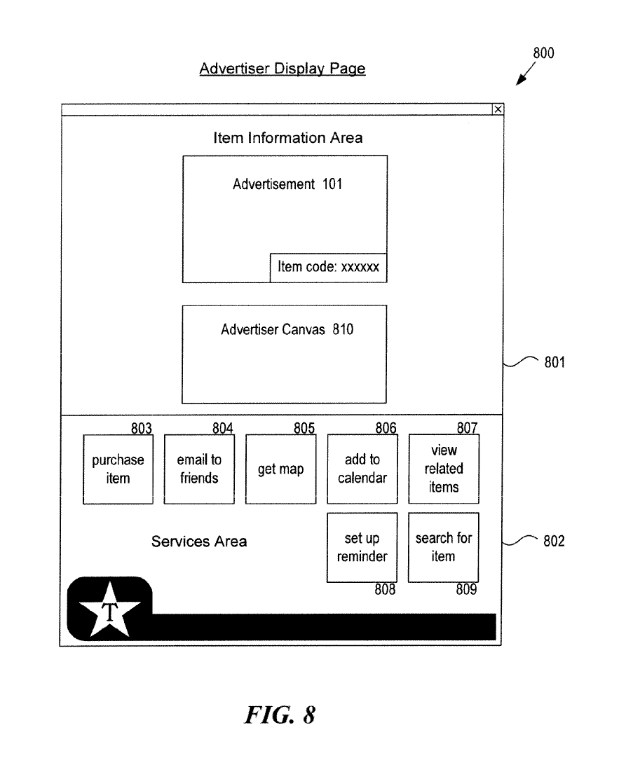

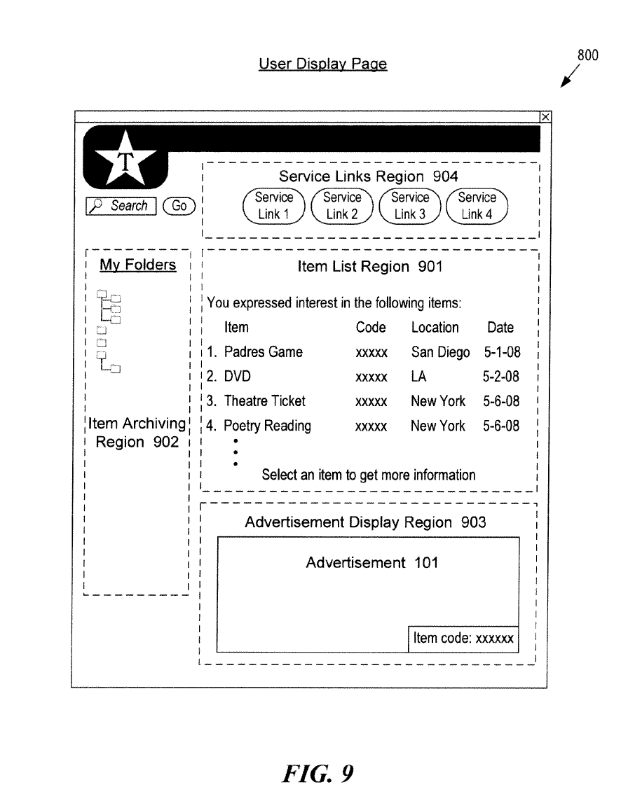

In one embodiment, the item message is sent in response to the user logging into a website of the item information system. In this embodiment, server 30 posts the item to a website in response to the user texting the item code (arrow 2). Upon logging into the website, server 30 delivers the item message in the form of a user display page 45 to the screen of the user's web browser enabled device 35. User display page 45 may include an item list of recently submitted item codes to allow the user to review past submissions (e.g., see FIG. 9). As the user builds a queue of item entries, the user can view the individual advertisements and related item information by selecting a particular item entry in the item list. Selecting the item entry causes the item information system to deliver another item message containing advertiser display page 50 to the user's web browser enabled device 35. In one embodiment, advertiser display page 50 (e.g., see FIG. 8) includes a representation of advertisement 15 along with additional information and links to related services, products or events.

The item information system provides a mechanism for a user to immediately (or subsequently) request additional item information at the time and place of initial interest in a traditional advertisement. This initial interest is then translated to a calendar request or an item entry accessible on the user's web browser enabled device 35. The user's web browser enabled device 35 then becomes the time shifted point of sale by providing convenient links to the advertiser online (arrow 6). Additionally (or alternatively), calendar system 55 can server as a reminder (arrow 5) for the user to purchase the event tickets at a later date. For example, the calendar entry may also include a box office phone number, which the user may call to purchase the tickets (arrow 7) to the event advertised. Thus, item information system is able to translate the traditional advertisement to the user's web browser enabled device 35, where the advertisement can be actionable and interactive for the user.

As text messages with various item codes from a variety of users arrive at the item information system, advertisement statistics are collected and summarized into an advertiser dashboard 40 (arrow 8). Advertiser dashboard 40 provides each advertiser using the item information system with unique, real-time, measurable results of the success or failure of their traditional advertisement campaigns without having to conduct expensive and time consuming polls or questionnaires. The above description in connection with dataflow environment 10 describes just a portion of the features provided by various embodiments of the item information system. The above features as well as additional features of the item information system are described in further detail below in connection with FIGS. 2-12.

In some embodiments, the item information system is implemented on a server that receives an item code submitted by a user, generates an item message that includes information identifying the item, and sends the item message to the user. For example, a billboard at an airport may display an advertisement for a restaurant in a nearby city and an item code (e.g., “AB102XC”) that is unique to the restaurant being advertised. A traveler at the airport, upon seeing the advertisement, who wants to get information about the restaurant and perhaps make a reservation may enter the item code via their mobile phone so that the item code can be automatically sent to the server (e.g., via a toll-free telephone call or SMS code to a number associated with the server or via a text message to the server). Upon receiving the item code and the identity of the traveler (e.g., based on a mapping of cell phone number to users), the server may retrieve item information associated with the item code and send an item message (e.g., via an electronic mail message or a text message) to the traveler. The item message may contain additional information about the restaurant and a link to a web page with further information. When the traveler views the electronic mail message and selects the link, a web page (e.g., advertiser display page 50 or user display page 45) hosted by the server is displayed to the traveler. Alternatively, the traveler that is a registered user of the item information system may elect to forego the electronic mail or text message return response and simply log into user display page 45. The web page may contain information about the restaurant (e.g., a menu) along with links to services relating to the restaurant. The services may include a mapping service through which directions to the restaurant can be provided, a reservation service through which reservations to the restaurant can be made, a review service through which reviews of the restaurant can be provided, a limousine service through which a reservation for transportation to the restaurant can be made, and so on.

In some embodiments, the item information system may be used to access information for products (e.g., DVDs, books, and jewelry), consumer services (e.g., investment advice), events (e.g., sporting and political events), charitable causes (e.g., Red Cross), emergency information (e.g., hurricane evacuation updates), and so on. The server generates web pages that are customized to the item corresponding to the item code. For example, the server may add to the web pages links to services that are appropriate for the item being advertised. If the item is a book, the server may add a link to a web page of a merchant through which the book can be purchased. Such links are sometimes referred to as “widgets.” When the user selects the link, the web page of the merchant may represent a shopping cart with the book already added to the shopping cart. The user can then simply check out to purchase the book. As another example, if the item relates to a charitable or political cause, the server may add a link to a web page for making a donation to the charitable or political cause. If the item relates to voter registration, the server may link to web pages of various counties through which the user can register to vote. If the item relates to a house that is for sale, the server may add links to a real estate agency, a mapping service, a property tax web page, and so.

In the following, an embodiment of the item information system is described in the context specific to scheduling of events followed by a more general description as it is applied to goods, products, services, events, and so on. A method and system for scheduling and/or providing information for events based on event codes distributed via advertisements is provided. In some embodiments, an event information system is implemented on a server that receives an event code submitted by a user, generates an event packet that may include a calendar request specifying the timing of the event and related information, and sends the event packet to the user. Upon receiving the event packet, the user can review the event information and accept the request to have the event added to the calendar of the user. Advertisers of events include event codes, which each uniquely identify an event, in advertisements for the events so that users can use the event codes to easily get information about the event and add the events to their calendars. The event information system may be used to review and schedule a variety of events, such as sporting events, theatrical events, governmental events, political events, educational events, business events, and so on.

For example, a promoter of a concert may add the event code to each printed advertisement for that concert. The promoter also registers the concert event with the event information system. When a person, referred to as a user of the event information system, sees the advertisement for the concert and is interested in attending or receiving more information about the event, the user can submit the event code by entering the event code into their mobile device and sending it via the Short Message Service (“SMS”) protocol to the event information system. When the SMS message is received (assuming that that user has already registered with the event information system), the event information system retrieves event scheduling and other information for the concert identified by the event code and identifies the user based on, for example, the telephone number of the mobile device. The event information system then generates an event packet including a calendar request that is appropriate for the calendar system of the user. The event information system may send the event packet via voice or text to the electronic mail address or mobile device of the user, including the mobile device through which the event code was submitted. When the user views the calendar request and event information of the event packet, the user can simply accept the calendar request to have the concert added to the user's calendar. The event information may include travel, retail, lodging, ticketing, and dining information tailored to the specific event. The event information system thus facilitates the adding events to calendars of users who are interested in the events. Moreover, the event information system provides a location-based platform for delivering goods and services to the user. For example, an event packet may include a recommendation for a hotel that is near the location of the event.

To use the event information system to facilitate the scheduling of an event, a sponsor or advertiser of an event first registers the event with the event information system. During the registration process for an event, the event information system assigns one or more event codes to the event and stores scheduling and related information for the event. For example, an event code may be a randomly generated number, alpha code, or alphanumeric code, may be provided by the advertiser, may be a character sequence that includes a code identifying to the advertiser, and so on. In another embodiment, the event codes may be bar codes, digital files, or digital images that are capable of being read optically or auditorially by reading devices such as mobile devices. The scheduling information for the event may include the location, start date and time and the end date and time for the event. The scheduling information may also include a description of the event, a link to a web page describing the event, a link to a web page for purchasing tickets for the event, links and advertisements for event-related products and services, and so on. Once the registration of the event is complete, the advertiser can start adding the event code to its advertisements. For example, the event code may be added to an advertisement posted on a billboard, added to an electronic advertisement (e.g., web page or electronic billboard) for the event, included in television or radio advertisements for the event, added to a newspaper advertisement for the event, and so on. When a user sees or hears (i.e., observes) such an advertisement, the users may submit that event code to the event information system.

To submit event codes to the event information system, a user registers with the event information system. During the registration process for a user, the event information system receives from the user information relating to mobile devices of the user, the user name, the user's electronic mail address, the calendar system used by the user, and possibly other information such as age, zip code, and gender. For example, a user may provide the telephone number of the user's mobile phone and an indication of that the user uses an Outlook, Yahoo, Google, Hotmail, or Airset calendar. Once the registration of the user is complete, the user may submit event codes to the scheduling system. The registration process may be conducted using various modes of communications via a text message system, an interactive voice recognition system (e.g., accessible via a telephone), web pages of a web site, or a combination of modes of communication.

When the scheduling system receives an event code submitted by a user, it may initially validate both the event code and the user. Assuming that both the event code and the user are valid, the event information system generates an event packet that includes event information and a calendar request specifying the start date and time and end date and time of the event and a description of the event. The event packet may be an electronic mail message that is formatted in accordance with the calendar system specified during user registration. The event information system sends the electronic mail message with the event information and the calendar request to the electronic mail address specified by the user during registration. Upon receiving the electronic mail message, the user can review the event information and accept or reject the calendar request to have the event added to the user's calendar. In some embodiment, the event information system may automatically add events directly to a user's calendar, rather than giving the user the option of accepting or declining the calendar request.

The event information system may allow an advertiser to use different event codes for a single event. The advertiser may use a different event codes or sub-codes to help differentiate the location of advertisements for the event, the advertisement media (e.g., billboard versus newspaper advertisement), the time of day when the advertisement was observed, and so on. For example, an advertiser may advertise a concert via billboards in six different cities using a different event code for each city. Over time, the advertiser may notice that out of 1000 event codes submitted, only 10 of the event codes are associated with a certain city. In such a case, the advertiser may conclude that the billboard advertisements in that city are not particularly effective or that the residents of the city are not interested in the concert. Depending on what the advertiser concludes, the advertiser may decide not to advertise in that city in the future or to advertise in that city using different billboard placements. The event information system may also derive location information from Global Positioning System (“GPS”), mobile phone triangulation, and other location information provided by a mobile device, when a user submits an event code. As another example, the advertiser may use a different event codes for radio and television advertisements. This allows the advertiser to help assess the cost effectiveness of each type of advertisement media. The event information system may also make demographic information of its users available to advertisers to help the advertisers in assessing the effectiveness of the advertisements. Given a static selection of media, an advertiser can measure and compare advertising effectiveness between campaigns. Through social, business, and other networking sites (e.g., Facebook, MySpace, and LinkedIn), the user may forward the event packet to other users who can view the event information and add the event to their calendar as appropriate.

The event information system may also facilitate the purchasing of tickets for an event. For example, the event information system may include a link to a web page for purchasing tickets to the event in a calendar request for the event. The link may include an identifier of the user. When a ticket is purchased, the user identifier may be recorded so that the advertiser can track which event codes resulted in actual purchases of tickets.

The event information system may also facilitate the inquiry into event-related products and services. For example, where the event is a play in New York City, the event information packet would include in addition to event information and calendaring options, a packet of location and event related goods and services advertising to the user. For example, such advertising could include airlines, local hotels, local restaurants, florists, limousine services, local art galleries, local retailers, etc.

The event information system may allow users to submit event codes through a variety of mechanisms. For example, a user may submit an event code via a text message mechanism of the user's telecommunication mobile device (e.g., cellular phone), which is sent to the event information system. Each advertisement may include, in addition to an event code, information describing how to send the event code (e.g., phone number, electronic mail address, and IP address). Users of mobile devices may store such information in their mobile device (e.g., in a contact list) for easy recall. Users may also submit event codes via a telephone (e.g., mobile phone or landline phone) by calling a number associated with the event information system and either speaking the event code or entering the event code via the dial pad. If the event information system does not have a registration associated with the phone number of the phone through which the event code was submitted, the event information system may prompt the user to enter their electronic mail address using the keypad of the telephone or by speaking their address. The event information system then sends the event information packet to that address along with a request that the user registers. Users may also submit event codes via a web page of the event information system accessible via a desktop computer, a laptop computer, a personal digital assistant, a mobile phone, and so on.

The event information system may also be used to support types of activities other than providing event scheduling and related information. For example, an advertiser of a product may include a “product code” for that product on its advertisements. The product code is analogous to the event code in the sense that it uniquely identifies a product of the advertiser. When a user submits a product code, it may be considered a request for product information or to purchase the product. A product information system would provide a packet of product information to the user via a communication channel (e.g., electronic mail, voicemail, text message, postal service, or express courier) selected by the user. A purchasing system upon receiving the request may charge the user for the product based on billing information provided by the user during registration and ship the product to the user at a delivery address provided by the user during registration.

The item information system may provide various metrics to help advertisers evaluate the effectiveness of the advertisements. For example, the item information system may provide reports and graphs identifying the number of item code submissions for an item code, click-throughs via an item message for the item code, click-throughs from a web page displayed as a result of an item message click-through. The reports and graphs may also provide profit and cost information such as profit or cost per click-through or item code submission. The reports and graphs may also break down the information based on geographic location and media type identified using different item codes, based on time of submission, based on location of submission (e.g., GPS or advertisement placement), based on user demographics, and so on. In one embodiment, the metrics collect for each advertiser are summarized in an advertiser dashboard (e.g., advertiser dashboard 40) remotely accessible in real-time via the Internet.

FIG. 2 is a functional block diagram illustrating components associated with an item information system, in accordance with embodiments of the invention. The components associated with the item information system may include advertisements 101, mobile devices 102, SMS channel 103, communications link 104, user computers 105, calendar servers 106, and an item information system 110. Each advertisement includes an item code that is registered with the item information system. Users submit the item codes via mobile devices as text messages that are transmitted via the SMS channel to the item information system. The item information system sends calendar requests via the communication link to user computer systems and calendar servers of the users. Although not shown, the item information system also interfaces with computer systems of advertisers for registering advertisers and items (e.g., products, services, events) and providing accounting and statistical information.

The item information system includes a user table 121, an item table 122, an advertiser table 123, and a transaction log 124. The user table contains user information obtained during registration of users. The item table contains item information obtained during registration of items. The advertiser table includes advertising information obtained during registration of advertisers. The transaction log contains an entry for each item code submitted to the item information system. The item information system also includes a register users component 131, a register items component 132, a schedule items component 133, a perform accounting component 134, an SMS interface component 135, a prepare display page component 136, and an identify item services component 137. The item information system may also include calendar system components 141 and 142 that provide logic for generating calendar requests for specific calendar systems.

FIG. 3A illustrates information stored in a user table and an item table in some embodiments. The user table 121 may include a user identifier (e.g., name or email address), a mobile device identifier (e.g., telephone number), an electronic mail address of the user, an indication of the calendar system of the user, an indication whether to automatically schedule items (e.g., services or events), credentials of the user, and so on. In some embodiments, the item information system may automatically add items to a user's calendar when automatic scheduling is enabled. In such a case, the item information system may use the user credentials to gain access to the user's calendar. The item table 122 may include an item code, a location, a start date and time, an end date and time, an item description, an advertiser identifier, an accounting plan, and so on. An accounting plan may specify how to charge for item scheduling services. For example, advertisers and/or users may be charged on a per item code submission basis, on a percent of resulting revenue basis, and so on. Alternatively, or in addition, revenue may be derived from additional advertisements provided to user. Also, revenue may be derived from providing accounting and statistical information to advertisers such as timing of submission of item codes, locations of submissions, demographics of users, and so on. In one revenue model, item code submissions and item scheduling services may be provided free of charge to advertisers and customers, while the statistical summary information, including timing of submission of item codes, locations of submissions, demographics of users, and so on, may be a fee premium service charged to the advertiser.

FIG. 3B is a block diagram that illustrates information stored in an advertiser table and a transaction log in some embodiments. The advertiser table 123 may include an advertiser identifier, an advertiser name, identifiers of various accounting plans that the advertiser may be authorized to use, and so on. The transaction log 124 may include a transaction date and time, a mobile device identifier, an item code, a status code, a mobile device location, and so on. The item information system may add a new record to the transaction log each time an item code is submitted.

The computing devices of the item information system may include a central processing unit, memory, input devices output devices, and storage devices, and communication ports. The memory and storage devices are computer-readable storage media that may be encoded with computer-executable instructions that implement the components of the item information system, which means a computer-readable storage medium that contains the instructions. In addition, the instructions, data structures, and message structures may be transmitted via a data transmission medium, such as a signal on a communication link.

The components of the item information system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

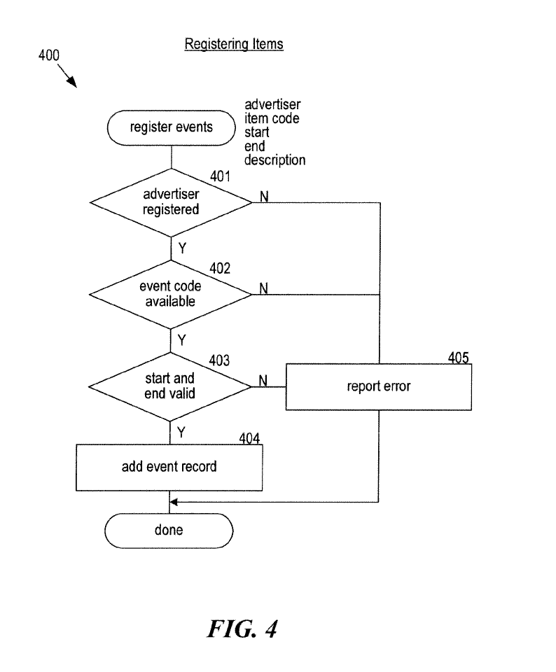

FIG. 4 is a flow chart illustrating a process 400 for operation of register items component 132 of the item information system in some embodiments. The component is invoked when an advertiser wants to register an item. The component is passed an advertiser identifier, an item code, a start and end date and time, a description of an item, and other information related to the item. In decision block 401, if the advertiser is registered as indicated by an entry in the advertiser table, then the process 400 continues to a block 402, else the process continues to block 405. In decision block 402, if the item code is available as indicated by no corresponding entry in the item table, then the process continues to block 403, else the process continues to block 405. In decision block 403, if the start and end dates and times are valid, then the process continues to block 404, else the process continues to block 405. In block 404, the process adds an item record for the item to the item table and then completes. In block 405, the process reports an error and then completes.

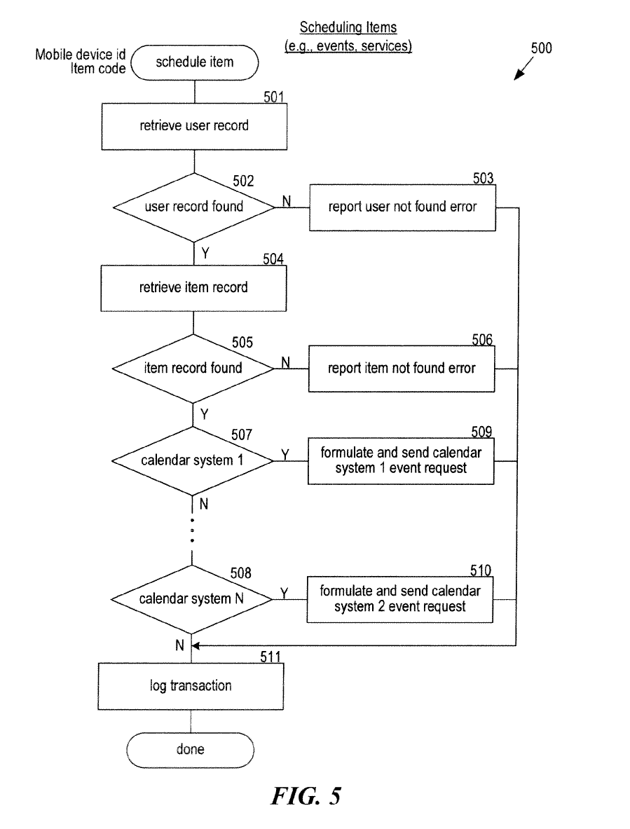

FIG. 5 is a flow chart illustrating a process 500 for operation of schedule items component 133 of the item information system in some embodiments. The component is invoked when an item code is submitted by a user. The component is passed an identifier of a mobile device and an item code. In block 501, the component retrieves the user record corresponding to the mobile device identifier from the user table. In decision block 502, if a user record was found, then process 500 continues at block 504, else the process continues at block 503 to report the error. In block 504, the component retrieves the item record corresponding to the item code from the item table. In decision block 505, if the item record is found, then process 500 continues at block 507, else process 500 continues at block 506 to report the error. In blocks 507-510, the component invokes the appropriate calendar system component to formulate a calendar request that is appropriate to the user's calendar system. In block 511, the component logs the transaction and completes.

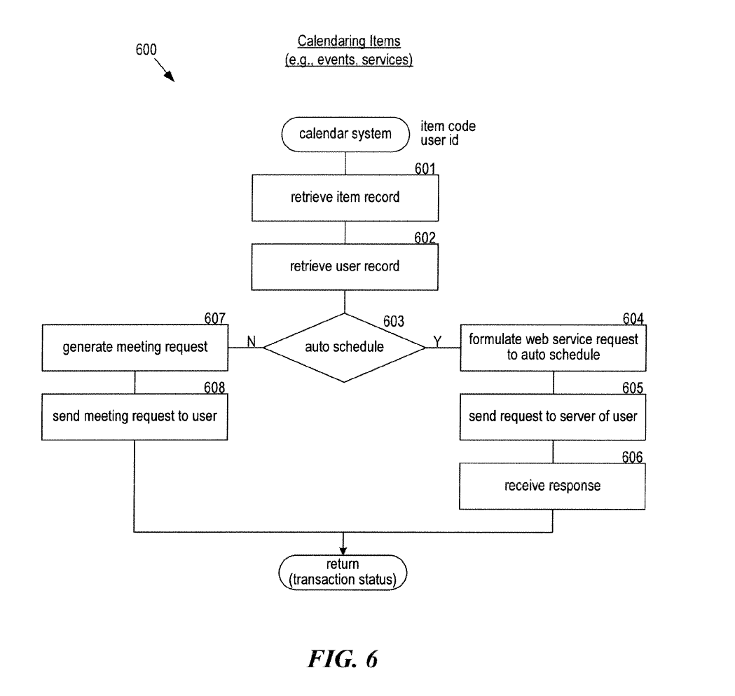

FIG. 6 is a flow chart illustrating a process 600 for operation of calendar system components 141, 142 in some embodiments. The component is passed an item code and a user identifier. In block 601, the component retrieves the item record from the item table for the item code. In block 602, the component retrieves the user record from the user table for the user identifier. In decision block 603, if the user record indicates to automatically schedule items (e.g., events, services), then process 600 continues at block 604, else process 600 continues at block 607. In block 604, the component formulates a web service request to automatically schedule the request. The calendar system may provide a web services interface for accessing calendar information. The service request may include the date and time of the item and the credentials of the user. In block 605, the component sends the request to the calendar server of the user. In block 606, the component receives a response indicating whether the request was successful and then returns. In block 607, the component generates a calendar request in the format of the calendar system (e.g., a Microsoft Outlook meeting request). In block 608, the component sends the calendar request to the user via an electronic mail message and then returns.

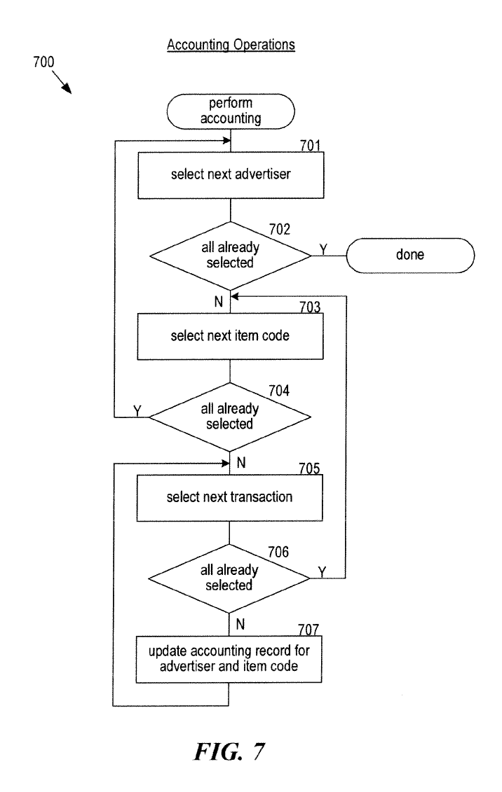

FIG. 7 is a flow diagram illustrating a process 700 for operation of perform accounting component 134 of the item information system in some embodiments. The component performs an accounting for each advertiser. In block 701, the component selects the next advertiser. In decision block 702, if all the advertisers have already been selected, then the component completes, else process 700 continues at block 703. In blocks 703-707, process 700 loops selecting each item code and transaction for the selected advertiser. In block 703, the component selects the next item code for the selected advertiser. In decision block 704, if all such item codes have already been selected, then process 700 loops to block 701 to select the next advertiser, else process 700 continues at block 705. In blocks 705-707, process 700 loops selecting each transaction for the selected item code. In block 705, the component selects the next transaction for the selected item code. In decision block 706, if all such transactions have already been selected, then process 700 loops to block 703 to select the next item code for the selected advertiser, else process 700 continues at block 707. In block 707, the component updates an accounting record for the selected advertiser and for the selected item code based on the selected transaction and then process 700 loops to block 705 to select the next transaction. Updating accounting records may include generating various metrics to help advertisers evaluate the effectiveness of the advertisements, as well as, generate accounting information for advertiser billing purposes.

FIGS. 8-12 illustrate various aspects of item information system 100, in accordance with some embodiments. FIG. 8 illustrates an advertiser display page 800 containing item information and links to services. Advertiser display page 800 is one possible embodiment of advertiser display page 50, illustrated in FIG. 1. Advertiser display page 800 may be displayed when a user selects a link within an electronic mail message sent to the user in response to the user entering an item code. The advertiser display page or item information page includes item information area 801 and services area 802.

The item information area contains information describing the item that is associated with the item code that the user entered. For example, the item may be an event, service, or product. The illustrated embodiment of item information area 801 includes a re-rendering (or modified representation thereof) of advertisement 101 originally seen by the user and advertiser canvas 810. Re-rendering advertisement 101 within item information area 801 provides a visual cue that reminds the user of the original advertisement that peaked the user's interest. Advertiser canvas 810 is a convenient location for the advertiser to provide additional information related to advertisement 101 to the user/consumer and may be used to link to virtual coupons or other promotions.

Advertiser canvas 810 is positioned in proximity to the reproduction of the original ad of interest (e.g., advertisement 101). Advertiser canvas 810 operates as a portal of communication between the advertiser and the registered user who represents a potential customer specifically interested in the advertisers wares. In one embodiment, advertiser canvas 810 is hosted by the item information system, but accessible and managed by the particular advertiser. This embodiment affords the advertiser the opportunity to communicate directly to their best potential customers with special offers, updates, discounts, promotions, etc., as long as, the user continues to retain the particular advertisement in their consumer queue (e.g., item list region 901).

The services area contains links 803-809 that can be clicked-through to services associated with the item. The links are to services and may be implemented as an HTTP request to retrieve a web page, a code that is executed as part of the display page (e.g., web widget), and so on. The services may be enabled or disabled or shown or not shown depending on the type of item. For example, if the item is a theatrical event, then the purchase item service 803 may represent a link to Ticketmaster.com that is passed a code representing the event. When the user selects the purchase item service, the Ticketmaster.com web page may be displayed with information relating to the theatrical event. The get map service 805 may represent a link to MapQuest.com that is passed the address of the theatre. As another example, if the item is a book, then the purchase item service may represent a link to Amazon.com that is passed the stock keeping unit (“SKU”) of the book. In this example, the map service may be disabled or may represent a link to MapQuest.com that is passed an address of a bookstore in the hometown of the user or near the current location of the user if current location information is available. The add to calendar service 806 may be disabled or may represent a link resulting in a book signing by the author being added to the user's calendar. In some embodiments, the parameters (e.g., SKU or theatre information) for the services may be passed as data of a display page that is not displayed to the user (i.e., hidden information). Services area 802 may also include links to social networking websites (e.g., Facebook, Linkedin, MySpace) to enable the user to quickly share the item with their friends and acquaintances. The service links displayed within services area 802 may include default service links, user specific service links updated automatically by the item information system based upon attributes of advertisement 101 currently being rendered in item information area 101, or user specific service links previously selected by the user from a list of available service links when configuring his/her account.

FIG. 9 illustrates a user display page listing items for which a user has recently entered item codes in some embodiments. User display page 900 is a sort of consumer queue or user homepage that may be displayed when the user goes to a website of the item information system. User display page 900 may be displayed after the user logs into the website. The illustrated embodiment of user display page 900 includes an item list region 901, an item archiving region 902, an advertisement display region 903, and service links region 904. The item list region 901 contains an entry for each recently entered item code. Each entry may identify the item and item code and further indicate where and when the item code was entered. For example, if the user enters the item code for a DVD via a cell phone, the server records the location and time of entry. The location of entry may be identified from Global Positioning System (GPS) information or other positioning information provided by the cell phone at the time of entry, deduced from cell phone location tracking information, or keyed to the location of the advertisement (e.g., billboard location), and so on. If the advertisement was run in a magazine or newspaper, or run on the television or radio, the location entry may include the name of the magazine or newspaper or the call numbers of the television or radio station. Although not illustrated, the consumer queue may include more or less columns than those illustrated in item list region 901. For example, a promotional column may be added enabling advertisers to add short messages (e.g., promotional offerings, enticements, and related information) associated with each item entry.

When a user selects an entry, the associated advertisement 101 is displayed in advertisement display region 903. If the user double clicks the selected entry or advertisement 101 itself, then the user is linked to the advertiser display page 800. Item archiving region 902 enables the user to organize or otherwise archive entries in item list region 901. Service links region 904 includes links to services related to items in item list area 901, such as links 803-809 described above, or may be configurable by the user. Some of the service links may be persistent links to commonly used services, some may change periodically based on advertiser requests, while still others may automatically change based on the item entries within item list region 901.

The consumer queue within item list region 901 may also be characterized as a universal shopping cart representing a user's commercial interests across a wide variety of products, services or events from various vendors. This universal shopping cart also can be thought of as a commercial or entertainment wish list. Although the embodiments disclosed herein are generally directed to capturing user interests in traditional advertising, it is within the scope of embodiments of the invention that the consumer queue or universal shopping cart can also be populated from online sources and advertisements. The consumer queue or universal shopping cart further facilitates cross product correlations based on the items in the queues of a number of users. These cross product correlations can help advertisers determine consumer interest correlations between products, services, or events for generating targeted advertisements.

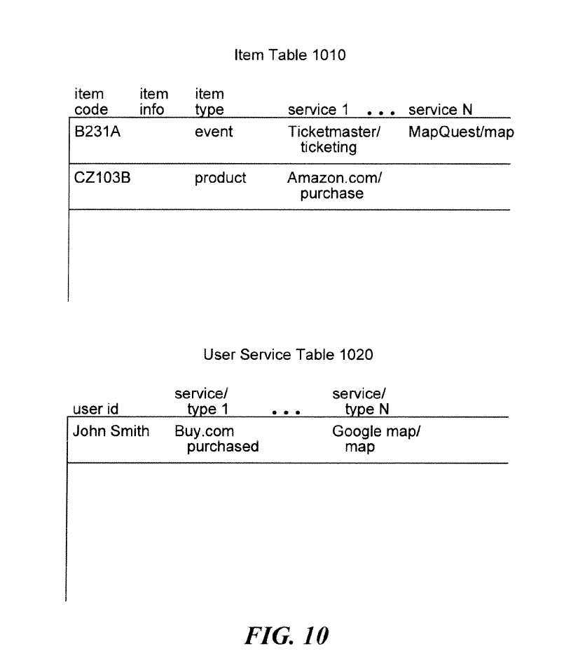

FIG. 10 illustrates tables containing item-related information in some embodiments. Item table 1010 contains an entry for an item for which an item code has been assigned. Each entry contains an item code field, an information field, an item type field, and service/type fields. The item code field contains the item code. The item information field contains a reference to information that is displayed in an item information area of a display page such as item information area 801 of advertiser display page 800. The item type field identifies the type of item (e.g., event, product, or service). The service/type fields identify each service and its type that is associated with the item. For example, an event may have a service of Ticketmaster.com and a service type of ticketing and a service of MapQuest.com and a service type of map, and a product may have a service of Amazon.com and a service type of purchase. Each entry can have its own set of service/type combinations. Although not shown, the item information system may maintain a table that maps item types to default service/type combinations. If an entry of the item table contains a service for a certain type, then that service may override the default service for that type.

User service table 1020 contains an entry for each user who has user service/type specific combinations. For example, one user may select a preferred merchant through which products are to be purchased. In this example, John Smith has indicated that the preferred service for purchases is Buy.com. When the item information system generates an advertiser or user display page for the user, it may override the services of the item table with the user preferred service for that type. Alternatively, the item information system may add links for both the default and overriding services (e.g., Amazon.com and Buy.com) to the display pages.

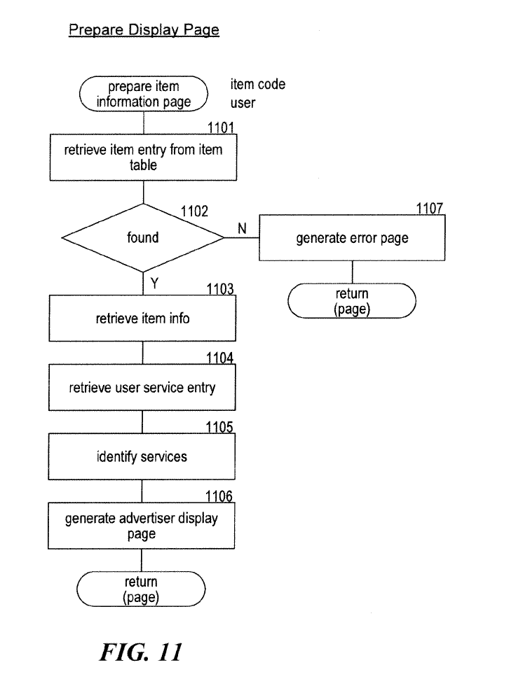

FIG. 11 is a flow chart illustrating a process 1100 for operation of a prepare display page component 136 of the item information system in some embodiments. The component is invoked when a user selects a link provided in an item message (e.g., electronic mail message) to the user. The component is passed an item code and user identifier that is passed as part of the request that is sent to the item information system when the link is selected. In block 1101, the component retrieves an item entry from the item table for the passed item code. In decision block 1102, if the item entry is found, then process 1100 continues at block 1103, else process 1100 continues at block 1107. In block 1103, the component retrieves the item information from the retrieved item entry. In block 1104, the component retrieves the entry for the user, if any, from the user service table. In block 1105, the component invokes an identify services component 137 to identify service links that should be included within services area 802 and/or service links region 904. In block 1106, the component generates advertiser display page 800 to include the retrieved item information and identified services and then returns the page. In block 1107, the component generates and returns an error page.

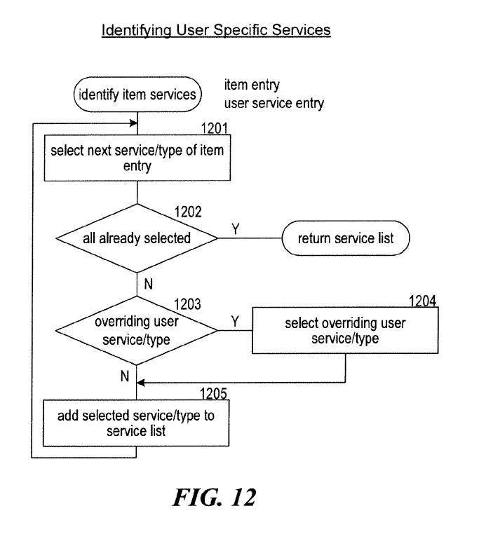

FIG. 12 is a flow chart illustrating a process 1200 for operation of an identify item services component 137 of the item information system in some embodiments. The component is passed an item entry from the item information table and a user service entry from the user services table. The component identifies and returns an indication of the services. In blocks 1201-1205, process 1200 loops selecting service/type combinations of the item entry and determining whether the user service entry has an overriding service. In block 1201, the component selects the next service/type combination of the item entry. In decision block 1202, if all the entries have already been selected, then a service list is returned, else the component continues at block 1203. In decision block 1203, if the user service entry has an overriding service/type combination, then process 1200 continues at block 1204, else process 1200 continues at block 1205. In block 1204, the component selects the overriding service/type and continues at block 1205. In block 1205, the component adds the selected service to the service list to be returned and loops to block 1201 to select the next service/type combination.

From the foregoing, it will be appreciated that specific embodiments of the invention have been described herein for purposes of illustration, but that various modifications may be made without deviating from the spirit and scope of the invention. For example, item codes may be added to advertisements for real estate such as to for sale signs of houses. A person passing by a house can enter the item code via their cell phone and receive an item information page for that house (either directly or indirectly via an electronic mail message with a link). The item information page may contain information describing the property and links to services that provide property information, insurance quote information, owner information, comparable listings, valuation information (e.g., Zillow.com), local schools information, and so on. The advertisements may include a telephone number associated with the item information system. A user can program that telephone number into their cell phone so that when the user sees another advertisement with an item code, the user does not need to reenter the telephone number and only needs to enter the new item code. The item information system may use various different revenue models. The item information system may charge advertisers for the initial assignment of item codes, on a per item code entry by a user, on a per click-through basis from item information pages, on a revenue sharing basis with the advertiser (e.g., percent of sale), and so on. In some embodiments, an item code may be added to a web page. In such a case, a selection of the item code may result in displaying of a web page with information about the item.

The order in which some or all of the process blocks appear in each process above should not be deemed limiting. Rather, one of ordinary skill in the art having the benefit of the present disclosure will understand that some of the process blocks may be executed in a variety of orders not illustrated.

The processes explained above may be described in terms of computer software and hardware. The techniques described may constitute machine-executable instructions embodied within a machine (e.g., computer) readable storage medium, that when executed by a machine will cause the machine to perform the operations described. Additionally, the processes may be embodied within hardware, such as an application specific integrated circuit (“ASIC”) or the like.

A machine-readable storage medium includes any mechanism that provides (i.e., stores) information in a form accessible by a machine (e.g., a computer, network device, personal digital assistant, mobile telecommunication device, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method in an item information system for providing item-related information, the method comprising:
providing an item mapping of item codes to item information related to the items;
providing a user mapping of user identifiers to user information;
receiving via a communication link an item code and a user identifier of a user who submitted the item code, the item code being provided to the user via an advertisement for the item;
retrieving item information for the received item code from the item mapping; and
sending an item message that includes a link to item information as indicated by the item mapping,
so that the user can obtain the item code from the advertisement, submit the item code to the item information system, and receive the item information related to the item of the advertisement.

2. The method of claim 1, wherein the user inputs the item code into a mobile telecommunication device and wherein the item message is posted to a website by the item information system in response to receiving the item code.

3. The method of claim 2, wherein the item message is sent to a web browser enabled device in response to the user accessing the website via the web browser enabled device.

4. The method of claim 3, wherein the website includes an advertiser display page for displaying the item information, the advertiser display page including:
a representation of the advertisement previously seen by the user when obtaining the item code; and
an advertiser canvas for displaying at least one of a service related to the advertisement, a coupon related to the advertisement, promotional offers related to the advertisement, or additional information related to the advertisement.

5. The method of claim 4, wherein the website includes a user display page, the user display page including an item information listing of item codes recently submitted in association with the user identifier, wherein the advertiser display page is accessible by selecting an associated entry within the item information listing.

6. The method of claim 5, wherein the item information listing further includes a location identifier associated with each entry when available, the location identifier including at least one of a location of where the user submitted the associated item code or a description of an advertising medium from which the user obtained the associated item code.

7. The method of claim 5, wherein the item information listing of item codes comprises a universal shopping cart for generating cross item correlations, the method further comprising:
determining consumer interest correlations between item entries in the universal shopping cart of a plurality of users of the item information system.

8. The method of claim 4, wherein the item information further includes links to services related to the advertisement and wherein the advertiser display page further includes click-through links to the services related to the advertisement.

9. The method of claim 2, wherein the item message includes a calendar request specifying start and end times of an event associated with the advertisement, the calendar request formatted for a calendar system installed on the web browser enabled device, start and end times derived from the item information, and calendar formatting derived from the user information.

10. The method of claim 2, further comprising gathering metrics related to submitted item codes to aid advertisers in evaluating effectiveness of non-Internet based advertisements.

11. The method of claim 10, wherein multiple item codes associated with a single item are used to differentiate attributes of advertisements, the attributes being selected from a group consisting of advertising media, advertisement versions, and advertisement locations.

12. The method of claim 1, wherein the communication link comprises a Short Message Service protocol and the item code comprises a text code provided along with the advertisement.

13. The method of claim 2, wherein the user inputs the item code into the mobile telecommunication device via an input mechanism selected from a group consisting of a bar code reader, an optical reader, an auditory reader, and a verbal message.

14. The method of claim 1, wherein:
the item code comprises at least one of the following: an event code related to a promotional event, a product code related to a product for sale, or a service code related to a service for sale,
the item information comprises at least one of the following: information describing the promotional event, information describing the product for sale, or information describing the service for sale.

15. The method of claim 2, wherein the user identifier comprises a phone number associated with the mobile telecommunication device.

16. The method of claim 2, wherein the advertisement comprises a non-Internet based advertisement and the item code is displayed on the non-Internet based advertisement.

17. The method of claim 2, further comprising:
receiving via the communication link location information from the mobile telecommunication device indicating a location of the telecommunication device when the item code was submitted by the user.

18. The method of claim 3, wherein the mobile telecommunication device and the web browser enabled device are a single device.

19. A machine-readable storage medium that provides instructions that, if executed by a networked server, will cause the networked server to perform operations comprising:
providing an item mapping of item codes to item information related to the items;
providing a user mapping of user identifiers to user information;
receiving via a communication link an item code and a user identifier of a user who submitted the item code, the item code being provided to the user via an advertisement for the item;
retrieving item information for the received item code from the item mapping; and
sending an item message that includes a link to item information as indicated by the item mapping,
so that the user can obtain the item code from the advertisement, submit the item code to the item information system, and receive item information to related products or services.

20. The machine-readable storage medium of claim 19, wherein the user inputs the item code into a mobile telecommunication device and wherein the item message is posted to a website by the item information system in response to receiving the item code, the website accessible by a web browser enabled device.

21. The machine-readable storage medium of claim 20, wherein the website includes an advertiser display page for displaying the item information, the advertiser display page including:
a representation of the advertisement previously seen by the user when obtaining the item code; and
an advertiser canvas for displaying at least one of a service related to the advertisement, a coupon related to the advertisement, promotional offers related to the advertisement, or additional information related to the advertisement.

22. The machine-readable storage medium of claim 21, wherein the website includes a user display page, the user display page including an item information listing of item codes recently submitted in association with the user identifier, wherein the advertiser display page is accessible by selecting an associated entry within the item information listing.

23. The machine-readable storage medium of claim 22, wherein the item information listing further includes a location identifier associated with each entry when available, the location identifier including at least one of a location of where the user submitted the associated item code or a description of an advertising medium from which the user obtained the associated item code.

24. The machine-readable storage medium of claim 20, wherein the item message includes a calendar request specifying start and end times of an event associated with the advertisement, the calendar request formatted for a calendar system installed on the web browser enabled device, start and end times derived from the item information, and calendar formatting derived from the user information.

25. The machine-readable storage medium of claim 20, further providing instructions that, if executed by the networked server, will cause the networked server to perform further operations, comprising:
gathering metrics related to submitted item codes to aid advertisers in evaluating effectiveness of non-Internet based advertisements.

26. The machine-readable storage medium of claim 25, wherein multiple item codes associated with a single item are used to differentiate attributes of advertisements, the attributes being selected from a group consisting of advertising media, advertisement versions, and advertisement locations.

27. A method in an event information system for providing event-related information, the method comprising:
providing an event mapping of event codes to event information and scheduling information for events;
providing a user mapping of user identifiers to user scheduling information;
receiving via a communication link an event code and a user identifier of a user who submitted the event code, the event code being provided to the user via an advertisement for an event;
retrieving event scheduling information for the received event code from the event mapping;
retrieving user scheduling information for the received user identifier from the user mapping; and
sending an event message that includes a calendar request specifying at least a start time derived from the retrieved event scheduling information formatted for a calendar system of the user in accordance with the retrieved scheduling information of the user,
so that the user can receive the event code from the advertisement, send the event code to the event information system, and receive calendar information from the event information system for adding the event to a calendar system of the user.

28. The method of claim 27, wherein the user inputs the event code into a mobile telecommunication device and wherein the event message is sent to a computer other than the mobile telecommunication device.

29. The method of claim 28, wherein the event code is provided with the advertisement selected from a group consisting of a magazine advertisement, a newspaper advertisement, a billboard advertisement, a poster advertisement, a radio advertisement, and a television advertisement.

30. The method of claim 27, further comprising:
providing a website including an advertiser display page for displaying the event information; and
updating the advertiser display page with the event information corresponding to the event code in response to receiving the event code, the advertiser display page including:
a representation of the advertisement previously seen by the user when obtaining the event code; and
an advertiser canvas for displaying at least one of a service related to the event, a coupon related to the event, a promotional offer related to the event, or additional information related to the advertisement.

31. The method of claim 30, wherein the website further includes a user display page, the user display page including an event information listing of event codes recently submitted in association with the user identifier, wherein the advertiser display page is accessible by selecting an associated entry within the event information listing.

32. The method of claim 31, wherein the event information listing further includes a location identifier associated with each entry when available, the location identifier including at least one of a location of where the user submitted the associated event code or a description of an advertising medium from which the user obtained the associated event code.

33. The method of claim 28, further comprising gathering metrics related to submitted event codes to aid advertisers in evaluating effectiveness of advertisements associated with the event codes.

34. The method of claim 33, wherein multiple event codes associated with a single event are used to differentiate attributes of advertisements, the attributes being selected from a group consisting of advertising media, advertisement versions, and advertisement locations.
